(19) United States
(12) Patent Application Publication
(10) Pub. No.: US 2005/0131910 A1
(43) Pub. Date: Jun. 16, 2005

(54) Server system of network provider

(75) Inventor: Takeshi Yanagisawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/044,206

(22) Filed: Jan. 28, 2005

Related U.S. Application Data
(63) Continuation of application No. PCT/JP02/07802, filed on Jul. 31, 2002.

(51) Int. Cl. G06F 17/30

(52) U.S. Cl. 707/10

(57) ABSTRACT

A server system of a network provider provides to a user a list of paid contents provided by content providers. The network provider collects fixed-rate charges from the user as the price for using the paid contents. Then, the network provider distributes the collected charges to the content providers based on how the contents are used.

### BACKGROUND OF THE INVENTION

1.) Field of the Invention

The present invention relates to a server system of an internet network provider who collects browsing charges of paysites from users on behalf of content providers who operates the paysites.

2.) Description of the Related Art

The development of internet technologies has enabled us to acquire various contents by use of a browser on the Internet from many content providers. Among them, there are many providers who run a paysite and provide their contents for charges.

However, users who use (browse, for example) contents on paysites are generally charged for each site because paysites are run independently by content providers. Accordingly, when the user uses a plurality of paysites, charges will be accumulated to increase user's costs for paysites. As a result, there are many users who are reluctant to use paysites from viewpoint of costs, which has been a problem in the conventional art.

Further, since users cannot judge security of a certain site that provides paid contents, there are users who are afraid that their personal information including their credit cards that they use for payment on the Internet may be abused. As a result, the number of users who use paysites will not increase, which has been another problem in the conventional art.

With regard to payments of service charges for these paid contents, many troubles have been seen in fact, and these troubles are anticipated to increase further in the future. Under such circumstances, the business development of the provision of paid contents on the Internet is hindered, which has been further another problem in the conventional art.

The present invention has been made to solve these problems with the conventional art. The object of the present invention is to provide information providing technology in which paid contents on the Internet are efficiently provided, and service charges for paid contents are efficiently and precisely collected. Thereby, the number of paid content providers and the use of services of the providers will be increased, and the business of providing paid contents on the Internet will be facilitated.

### SUMMARY OF THE INVENTION

It is an object of the present invention to at least solve the problems in the conventional technology.

An information providing method according to an aspect of the present invention is executed by a server system of an internet network provider that connects to the Internet an information processing apparatus of a user authorized to access to contents provided by content providers in the Internet. The method includes creating a content list that is a list of the contents; receiving from the information processing apparatus a request for the content list; sending the content list to the information processing apparatus in response to the request for the content list; receiving from the information processing apparatus a request for a specific content included in the content list sent; acquiring the specific content; sending the specific content acquired to the information processing apparatus; accumulating, for a predetermined duration, information about use of the contents in the content list created; and calculating dividends to the content providers, based on the information accumulated.

An information providing method according to another aspect of the present invention is executed by a server system of an internet network provider that connects to the Internet an information processing apparatus of a user authorized to access to contents provided by content providers in the Internet. The method includes registering the contents to the server system; creating a content list that is a list of the contents registered; receiving from the information processing apparatus a request for the content list; sending the content list to the information processing apparatus in response to the request for the content list; receiving from the information processing apparatus a request for a specific content included in the content list sent; sending the specific content included in the contents registered to the information processing apparatus; accumulating, for a predetermined duration, information about use of the contents registered; and calculating dividends to the content providers, based on the information accumulated.

A server system an internet network provider according to still another aspect of the present invention connects to the Internet an information processing apparatus of a user authorized to access to contents provided by content providers in the Internet. The server system includes a creating unit that creates a content list that is a list of the contents; a receiving unit that receives from the information processing apparatus a request for the content list; a sending unit that sends the content list to the information processing apparatus in response to the request for the content list; a receiving unit that receives from the information processing apparatus a request for a specific content included in the content list sent; a acquiring unit that acquires the specific content; a sending unit that sends the specific content acquired to the information processing apparatus; a accumulating unit that accumulates, for a predetermined duration, information about use of the contents in the content list created; a memorizing unit that memorizes the information accumulated; and a calculating unit that calculates dividends to the content providers, based on the information memorized.

A server system an internet network provider according to still another aspect of the present invention connects to the Internet an information processing apparatus of a user authorized to access to contents provided by content providers in the Internet. The server system includes a registering unit that registers the contents; a creating unit that creates a content list that is a list of the contents registered; a receiving unit that receives from the information processing apparatus a request for the content list; a sending unit that sends the content list to the information processing apparatus in response to the request for the content list; a receiving unit that receives from the information processing apparatus a request for a specific content included in the content list sent; a sending unit that sends the specific content included in the contents registered to the information processing apparatus; a accumulating unit that accumulates, for a predetermined duration, information about use of the contents registered; a memorizing unit that memorizes the information accumulated; and a calculating unit that calculates dividends to the content providers, based on the information memorized.

Computer-readable recording medium according to still other aspects of the present invention store computer programs that cause computers to execute the above methods according to the present invention.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a schematic for outlining an information providing system according to a first embodiment of the present invention;

FIG. 2 is a schematic of a system configuration of the information providing system;

FIG. 3 is a block diagram of a hardware configuration of a server system of a network provider;

FIG. 4 is a block diagram of a hardware configuration of a portable information processing terminal of a user;

FIG. 5 is a block diagram of a functional configuration of the server system;

FIG. 6 is a flow chart of content list information creation/registration process executed by the server system;

FIG. 7 is a flow chart of content providing process executed by the server system;

FIG. 8 is a flow chart of service condition acquiring process executed by the server system;

FIG. 9 is a flow chart of service condition acquiring process executed by the server system;

FIG. 10 is a flow chart of process procedures of software that is distributed to the user;

FIG. 11 is an example of a portal homepage;

FIG. 12 is a flow chart of operating procedures of the user;

FIG. 13 is a flow chart of operating procedures of the network provider;

FIG. 14 is a flow chart of operating procedures of a content provider;

FIG. 15 is a schematic for outlining an information providing system according to a second embodiment of the present invention;

FIG. 16 is a block diagram of a functional configuration of a server system of the network provider;

FIG. 17 is a flow chart of content registration process executed by the server system;

FIG. 18 is a flow chart of content providing process executed by the server system;

FIG. 19 is a flow chart of operating procedures of the network provider; and

FIG. 20 is a flow chart of operating procedures of the content provider.

### DETAILED DESCRIPTION

Exemplary embodiments of an information providing method, a computer-readable recording medium, and a server system according to the present invention will be explained in detail with reference to the accompanying drawings.

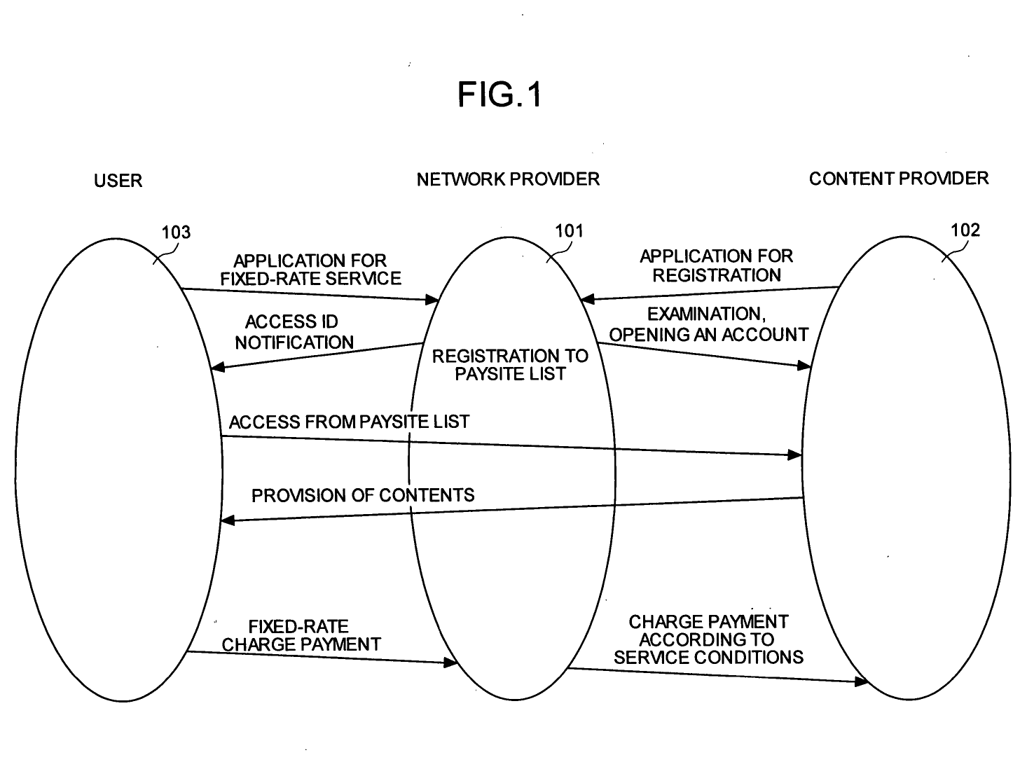

FIG. 1 is a schematic for outlining an information providing system according to a first embodiment of the present invention. In FIG. 1, a network provider 101 is what is called an Internet Service Provider (ISP) who collects internet access fee, and in the present invention, on behalf of a content provider 102, collects charges from a user 103 who has used a paysite.

The content provider 102 is a content provider who runs the paysite. Contents provided by the content provider 102 include, for example, text, image, audio, video and so forth. There are paid contents and free contents, but in principle, the contents provided by the content provider 102 are paid contents. The user 103 is a user who uses (browses, listens to and views) the paid contents.

The content provider 102 makes an application for registration of paysite to the network provider 101. The application can be made via the Internet, or by storing contents into a recording medium and sending it by a postal mail, or other means. In response to the application, the network provider 101 conducts an examination, registers the paysite to a paysite list, and instructs the content provider 102 to open an account for payment of a dividend.

The user 103 applies for a fixed-rate service for paysites to the network provider 101. In response to the application, the network provider 101 informs the user 103 of an access ID. The access ID is an ID necessary for the user 103 to use the paysites available at fixed-rate charges. The ID can be same as or different from a personal ID to connect to the Internet. It is also possible to guarantee the user's identity by use of an IC/ID card for personal identification or the like.

Thus, the environment for the user 103 to use the paysites, without being conscious about money, is prepared. The user 103 who has acquired the access ID accesses to paysites through a portal homepage (the paysite list) which contains only paysites available at fixed-rate charges. Thus, the user 103 receives the provision of contents via the network provider 101. Paysites of the content providers 102 are registered, after examination by the network provider 101, in the portal homepage. The user 103 can use the paysites on the portal homepage at fixed-rate charges without an upper limit. The user 103 pays the fixed-rate charges to the network provider 101, and the network provider 101 pays dividends to the content provider 102 according to how the contents are used (for example, how many times accesses were made to the contents).

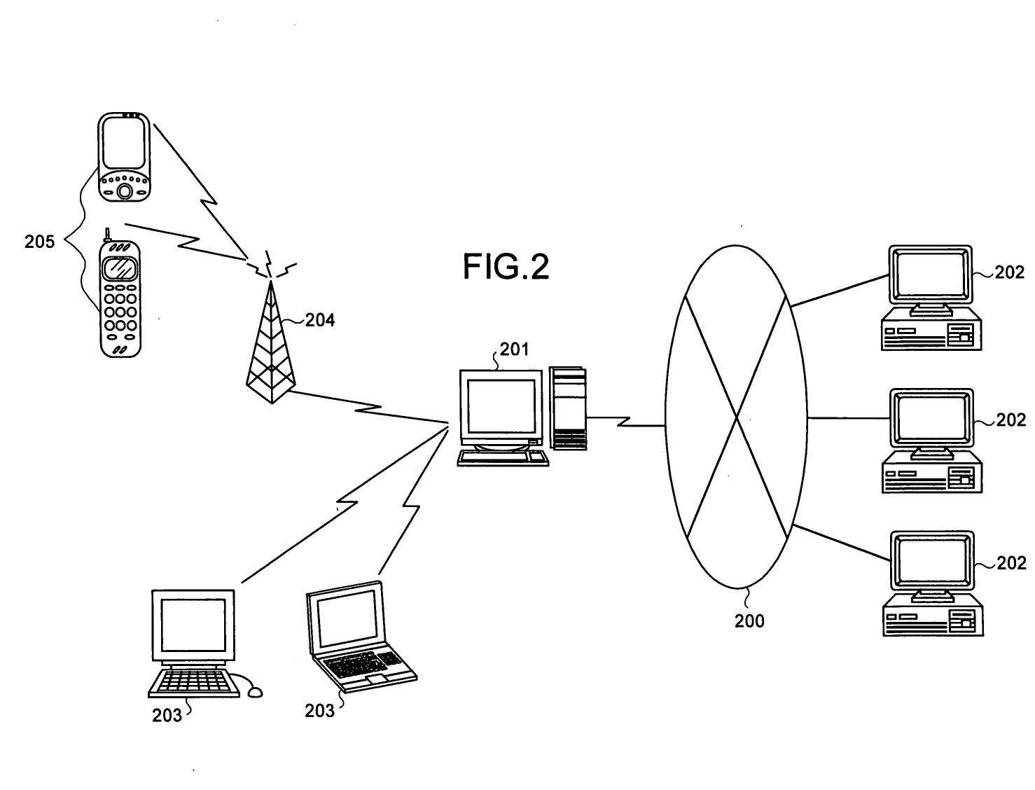

FIG. 2 is a schematic of a system configuration of an information providing system according to the first embodiment of the present invention. As shown in FIG. 2, the information providing system includes the Internet 200, a server system 201 of the network provider 101, a server system 202 of the content provider 102, an information processing apparatus 203 of the user 103, a radio station 204, and a portable information processing terminal 205 of the user 103.

The information processing apparatus 203 of the user 103 is connected to the server system 201 by a telephone line or the like. The server system 201 is connected to the server system 202 of each content provider 102 via the Internet 200. The user 103 can connect to the server system 201 by use of the portable information processing terminal 205 and the radio station 204.

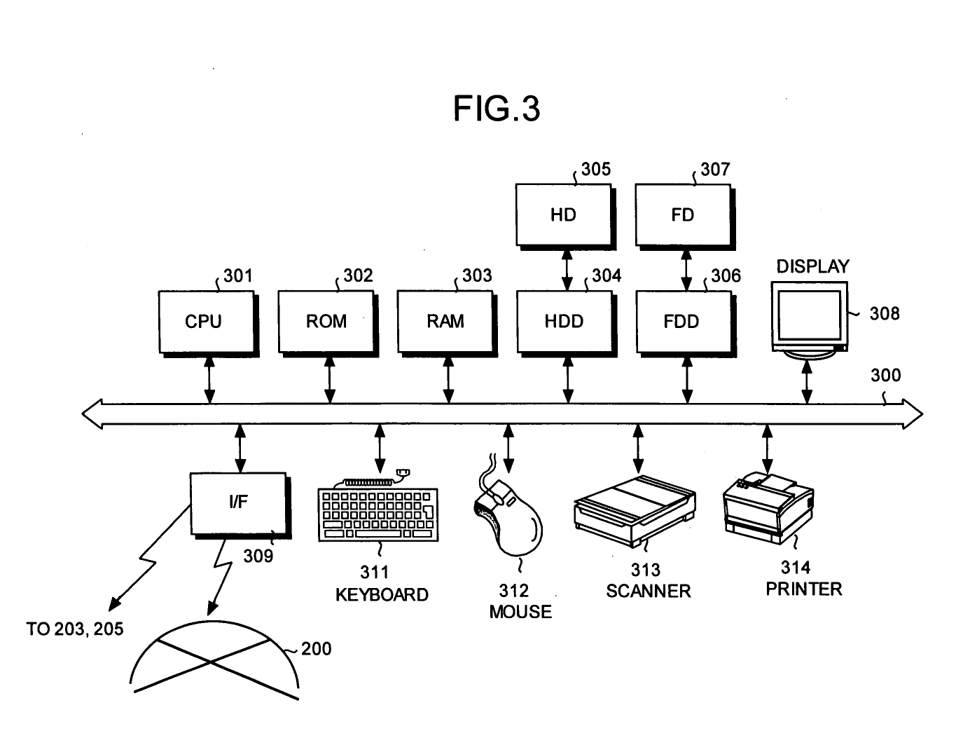

FIG. 3 is a block diagram of an example of a hardware configuration of the server system 201 according to the first embodiment.

As shown in FIG. 3, the server system 201 has a CPU 301, a ROM 302, a RAM 303, a hard disk drive (HDD) 304, a hard disk (HD) 305, a flexible disk drive (FDD) 306, a flexible disk (FD) 307 as an example of detachable recording media, a display 308, an interface (I/F) 309, a keyboard 311, a mouse 312, a scanner 313, and a printer 314. The respective components are connected via a bus or cable 300.

The CPU 301 controls the entire server system 201. The ROM 302 memorizes programs such as a boot program. The RAM 303 is used as a work area of the CPU 301. The HDD 304 controls reading/writing of data to the HD 305 under the control of the CPU 301. The HD 305 memorizes data written by the control of the HDD 304.

The FDD 306 controls reading/writing of data to the FD 307 under the control of the CPU 301. The FD 307 memorizes data written by the control of the FDD 306, and makes the memorized data read by a magnetic head of the FDD 306. As a detachable recording medium, besides the FD 307, a CD-ROM (CD-R, CD-RW), an MO (Magneto Optical Disk), a DVD (Digital Versatile Disk), a memory card or so can be employed. The display 308 displays such as a cursor, icons, tool boxes, and windows contains texts, images, items for control and the likes. As the display 308, for example, a CRT, a TFT liquid crystal display, a plasma display and the like can be employed.

The I/F 309 is connected to the Internet 200, and connected to other information processing apparatuses via the Internet 200. The I/F 309 sends and receives data between the Internet 200 and the device inside, and controls data input and output from and to the other information processing apparatus. The I/F 309 is also connected to the information processing apparatus 203 and the portable information processing terminal 205 via a general telephone line. As the I/F 309, for example a modem or the like can be employed.

The keyboard 311 has keys for inputting characters, numeric values, various instructions and the likes, and thereby inputs data to the device inside. Meanwhile, a touch panel type input pad or ten keys can be also employed. The mouse 312 moves the cursor, selects screen areas, and moves windows, and changes the sizes thereof. Instead of the mouse, a track ball, a joy stick, a cross key, a jog dial or the like can be employed, so long as it has similar functions as a pointing device.

The scanner 313 reads images optically, and takes image data into the device inside. The printer 314, which can be for example a laser printer or an ink jet printer, prints out image data and text data.

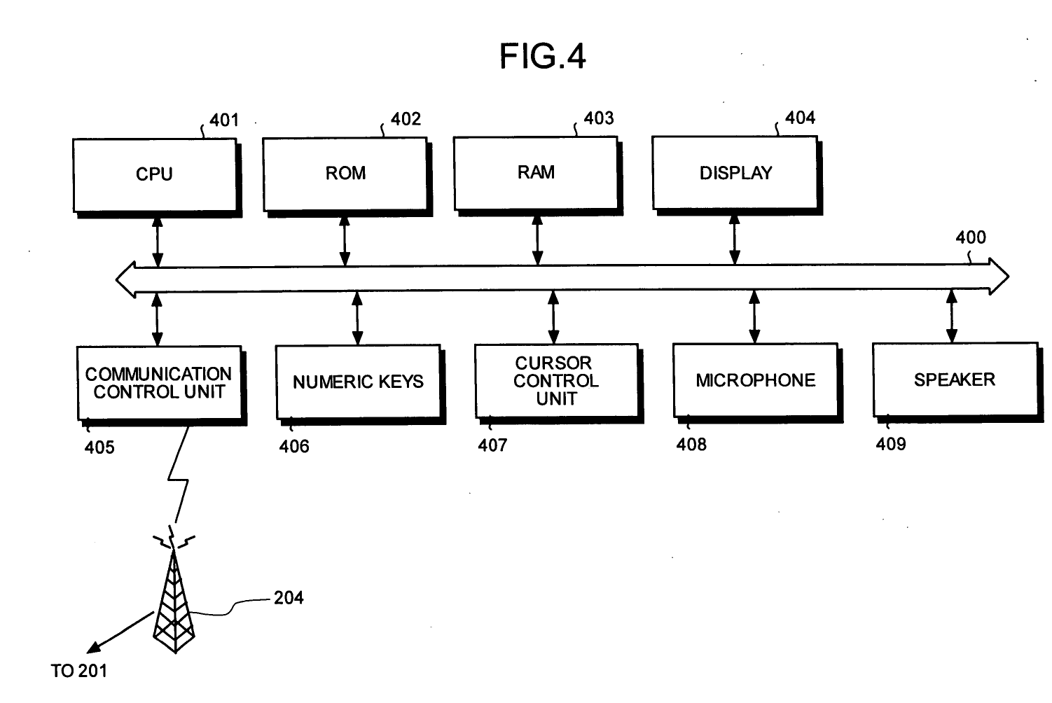

A hardware configuration of the information processing apparatus 203 and the portable information processing terminal 205 according to the first embodiment is explained next. The hardware configuration of the information processing apparatus 203, such as a personal computer (PC), is the same as that of the server system 201 shown in FIG. 3. FIG. 4 is a block diagram of an example of a hardware configuration of the portable information processing terminal 205 according to the first embodiment. Herein, a cell phone is taken as a representative example of the portable information processing terminal 205. However, this is just one example, and for instance, a Personal Digital Assistant (PDA) or a standalone type or notebook PC or the like can be employed.

As shown in FIG. 4, the cell phone 205 has a CPU 401, a ROM 402, a RAM 403, a display 404, a communication control unit 405, numeric keys 406, a cursor control unit 407, a microphone 408, and a speaker 409. The respective components are connected via a bus 400.

The CPU 401 controls the entire cell phone 205. The ROM 402 memorizes programs such as a boot program. The RAM 403 is used as a work area of the CPU 401. The display 404, that can be for example a TFT liquid crystal display, displays a cursor, icons, tool boxes, and data such as texts and images, items for control and the likes.

The communication control unit 405 controls the transmission of radio waves with the radio station 204, and is connected to the server system 201 by the radio station 204. The communication control unit 405 also controls sending and receiving data between the server system 201 and the device inside, and controls data input and output with the server system 201.

The numeric keys 406 have keys for inputting characters, numeric values, and various instructions and the likes, and thereby input data to the device inside. The cursor control unit 407 moves the cursor, and selects screen areas and the likes. A cross key, a jog dial or the like can be employed, so long as it has similar functions as a pointing device. The microphone 408 converts input voices into electric signals. The speaker 409 converts input electric signals into voices and outputs them. Both the microphone 408 and the speaker 409 have functions as a telephone.

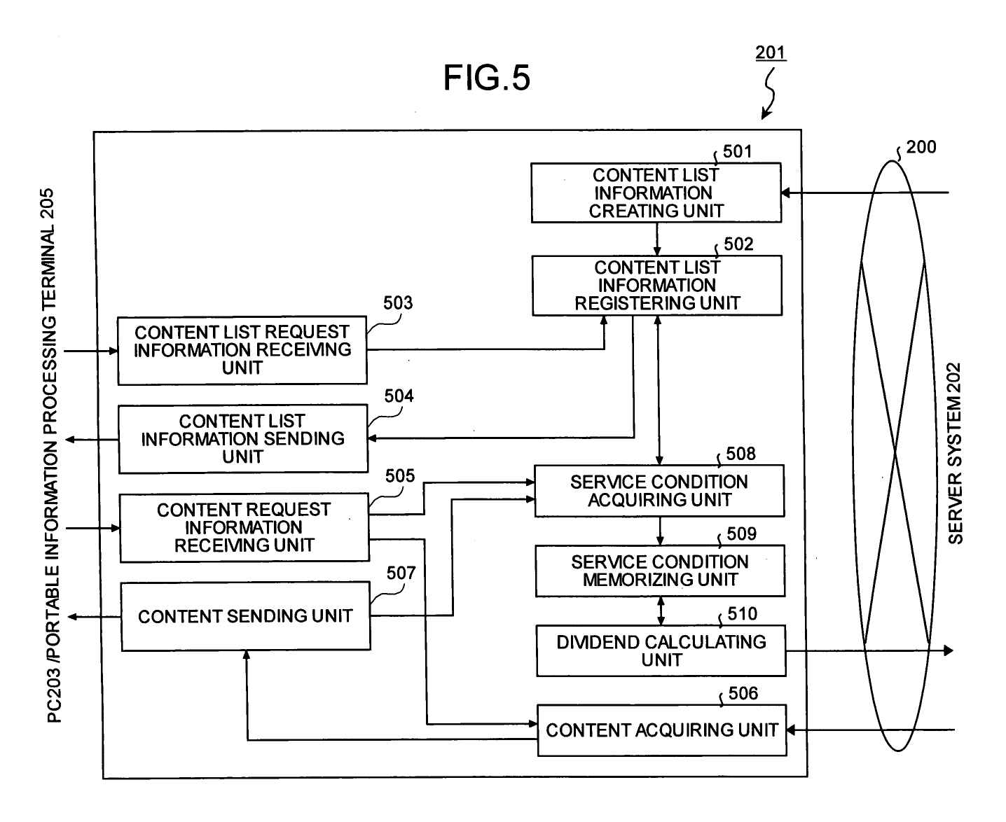

FIG. 5 is a block diagram of a functional configuration of the server system 201 according to the first embodiment. As shown in FIG. 5, the server system 201 includes a content list information creating unit 501, a content list information registering unit 502, a content list request information receiving unit 503, a content list information sending unit 504, a content request information receiving unit 505, a content acquiring unit 506, a content sending unit 507, a service condition acquiring unit 508, a service condition memorizing unit 509, and a dividend calculating unit 510.

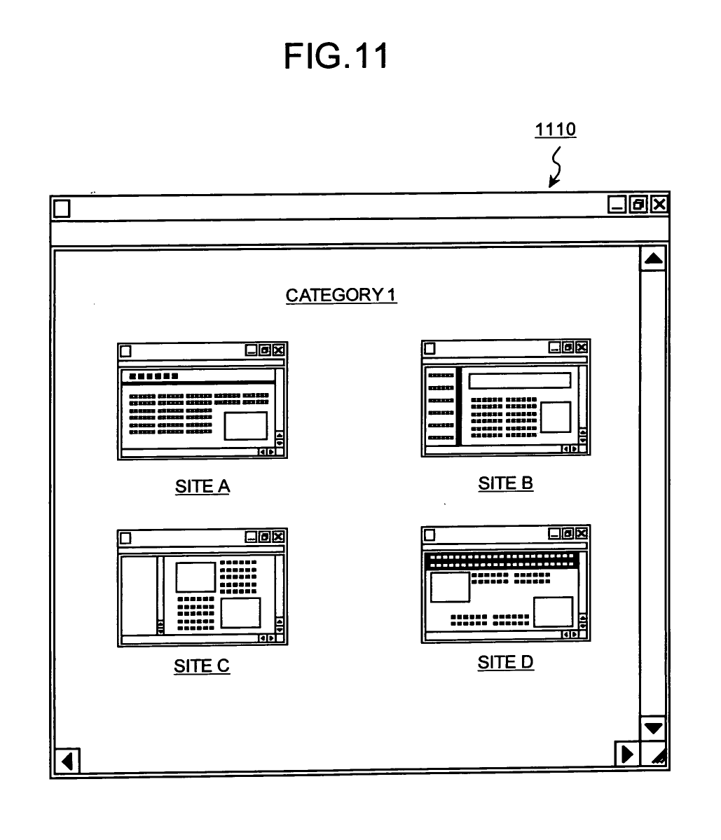

The content list information creating unit 501 creates content list information concerning a list of contents provided by the content provider 102. The contents of the content list information are described later in FIG. 11. The content list information creating unit 501 is realized by the CPU 301 reading a program stored in such as the HD 305 and the FD 307 shown in FIG. 3, out to the RAM 303.

The content list information registering unit 502 registers content list information created by the content list information creating unit 501. The content list information registering unit 502 is realized by, for example the HD 305 shown in FIG. 3, and the HDD 304 that controls the HD.

The content list request information receiving unit 503 receives content list request information from the PC 203 or the portable information processing terminal 205 of the user 103 who is authorized to use the contents. The content list request information is concerning a request for the content list information registered by the content list information registering unit 502. The content list request information receiving unit 503 is realized by, for example the I/F 309 shown in FIG. 3.

The content list information sending unit 504 sends the content list information registered by the content list information registering unit 502 to the PC 203 or the portable information processing terminal 205 of the user 103, in response to the content list request information received by the content list request information receiving unit 503. The content list information sending unit 504 is realized by, for example the I/F 309 shown in FIG. 3.

The content request information receiving unit 505 receives content request information from the PC 203 or the portable information processing terminal 205 of the user 103. The content request information is concerning a request for a specific content that is designated by the user 103 in the content list information sent by the content list information sending unit 504. The content request information receiving unit 505 is realized by, for example the I/F 309 shown in FIG. 3.

The content acquiring unit 506 acquires contents via the Internet 200 from the server system 202 of the content provider 102, in response to the content request information received by the content request information receiving unit 505. The content acquiring unit 506 is realized by the CPU 301 that reads a program, which is stored in such as the HD 305 and the FD 307 shown in FIG. 3, out to the RAM 303, and by the I/F 309 shown in FIG. 3.

The content sending unit 507 sends the contents acquired by the content acquiring unit 506 to the PC 203 or the portable information processing terminal 205 of the user 103. The content sending unit 507 is realized by, for example the I/F 309 shown in FIG. 3.

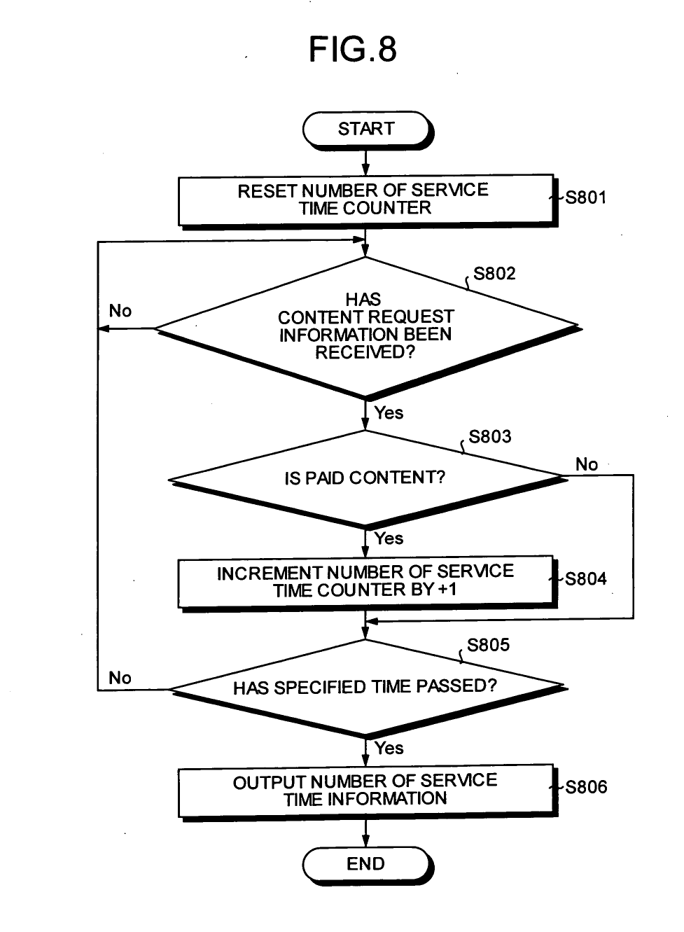

The service condition acquiring unit 508 acquires information concerning the service conditions of the contents registered by the content list information registering unit 502. The information concerning the service conditions can be information concerning the number of service times of contents. In this instance, the service condition acquiring unit 508 acquires information concerning the service conditions based on (1) information concerning the receiving conditions of the content request information received by the content request information receiving unit 505 or (2) information concerning the sending conditions of the contents sent by the content sending unit 507. The details thereof are described later in FIG. 8.

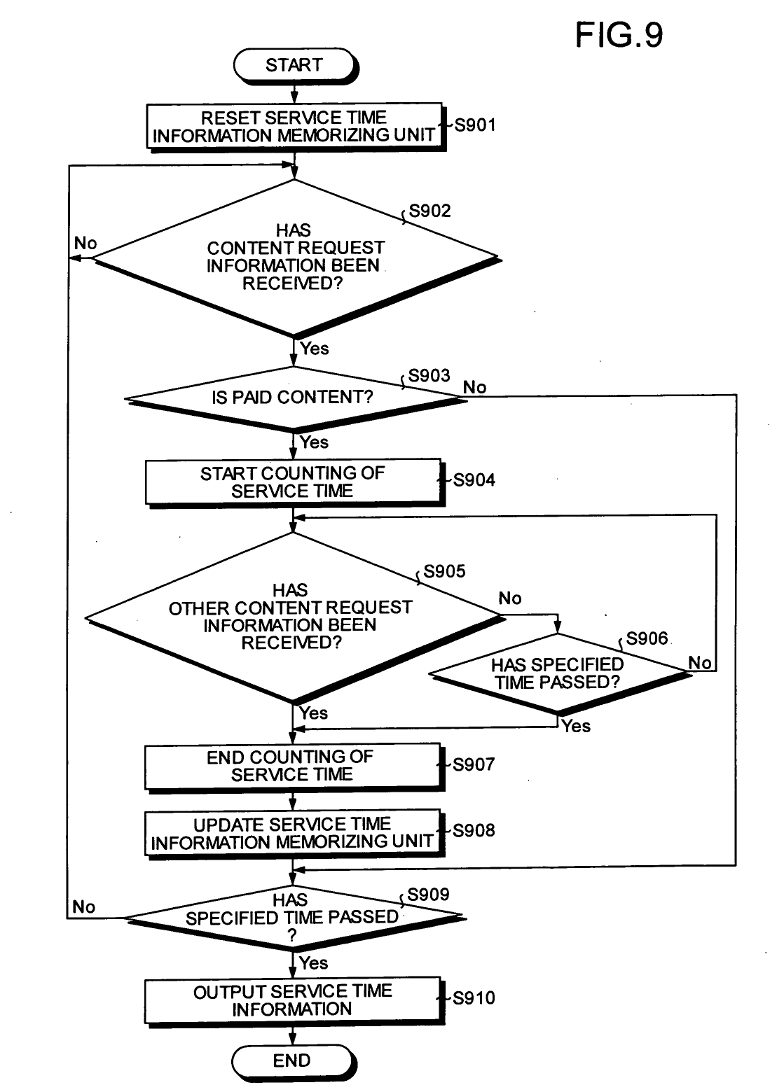

The information concerning the service conditions can also be information concerning service time of contents. In this instance, the service condition acquiring unit 508 acquires information concerning the service conditions based on (1) information concerning the sending conditions of the contents sent by the content sending unit 507 and (2) information concerning the receiving conditions of the content request information received by the content request information receiving unit 505. The details thereof are described later in FIG. 9.

The service condition acquiring unit 508 is realized by the CPU 301 reading a program stored in such as the HD 305 and the FD 307 shown in FIG. 3, out to the RAM 303.

The service condition memorizing unit 509 memorizes the information concerning the service conditions of contents acquired by the service condition acquiring unit 508. The service condition memorizing unit 509 is realized by, for example the HD 305 and the HDD 304 that controls the HD 305 shown in FIG. 3.

The dividend calculating unit 510 calculates dividends to the content provider 102, based on the information concerning the service conditions of contents memorized by the service condition memorizing unit 509. The dividend calculating unit 510 is realized by the CPU 301 reading a program stored in such as the HD 305 and the FD 307 shown in FIG. 3, out to the RAM 303.

The calculation of dividends, i.e., the distribution of fixed-rate charges collected from the user 103 is explained next. Generally, the charges are distributed to the content provider 102 in proportion with the number of browsing times or browsing time. However, it is preferable to divide the paysites into specific categories and to divide dividends proportionally in the categories (in other words, it is preferable not to compare all the paysites under uniform conditions), because browsing can concentrate only to a specific site which is very popular.

It is also possible to distribute a constant sum of money to the content provider 102, irrespective of the number of browsing times or browsing time. However, by combining proportional distribution and fixed-rate distribution, it is possible to make an extremely biased distribution where high dividends are distributed to only three top content providers and no dividend is paid to other sites. It is also possible to adopt a distribution method where little ranking is arranged among high ranked content providers, and fixed-amount dividends are distributed to providers below a specific ranking. The distribution method can be determined by the network provider 101 in consideration of characteristics of categories and contents thereof. By distributing much more charges to high-ranking content providers 102, it is expected that sound competitions are made among content providers 102 and the contents are refined further more. It is also expected that a content provider 102 of a new category, which has not opened a paysite so far, opens a paysite to gain the benefits of dividends. For example, a non profit organization can obtain the funds for its activities by opening a paysite.

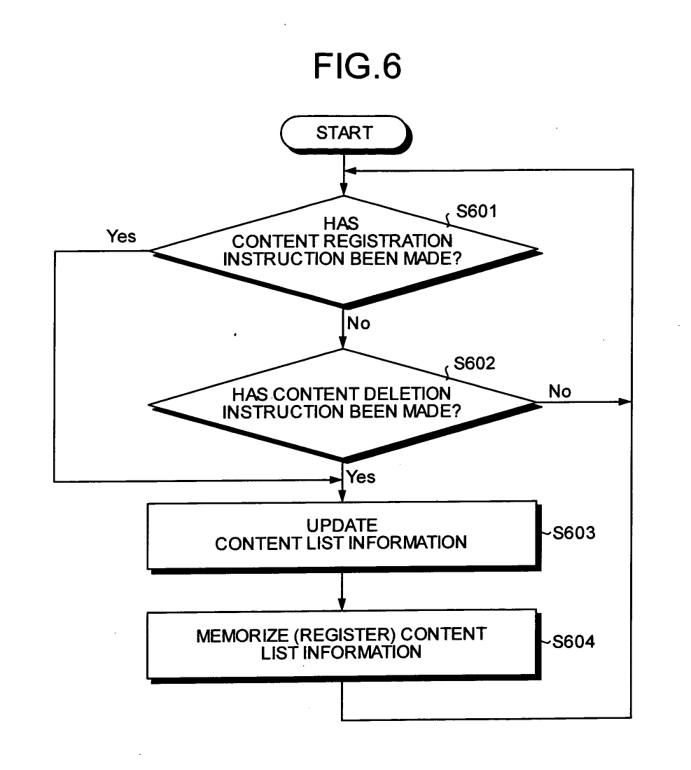

FIG. 6 is a flow chart of content list information creation/registration process executed by the server system 201 according to the first embodiment. After the application and the examination, it is judged whether a content registration instruction has been made (step S601), and further it is judged whether a content deletion instruction has been made (step S602).

When there is not either the content registration instruction or the content deletion instruction (step S601: No and step S602: No), the procedures go back to the step S601. On the other hand, when there is either the content registration instruction or the content deletion instruction (step S601: Yes or step S602: Yes), content list information is updated by creating new content list information or changing existing content list information (step S603). Then, the created or changed content list information is memorized (registered) (step S604). Thereafter, the procedures go back to the step S601, where the same process is carried out repeatedly. The creation/change of content list information is carried out at any time, and the user 103 can acquire always latest content list information.

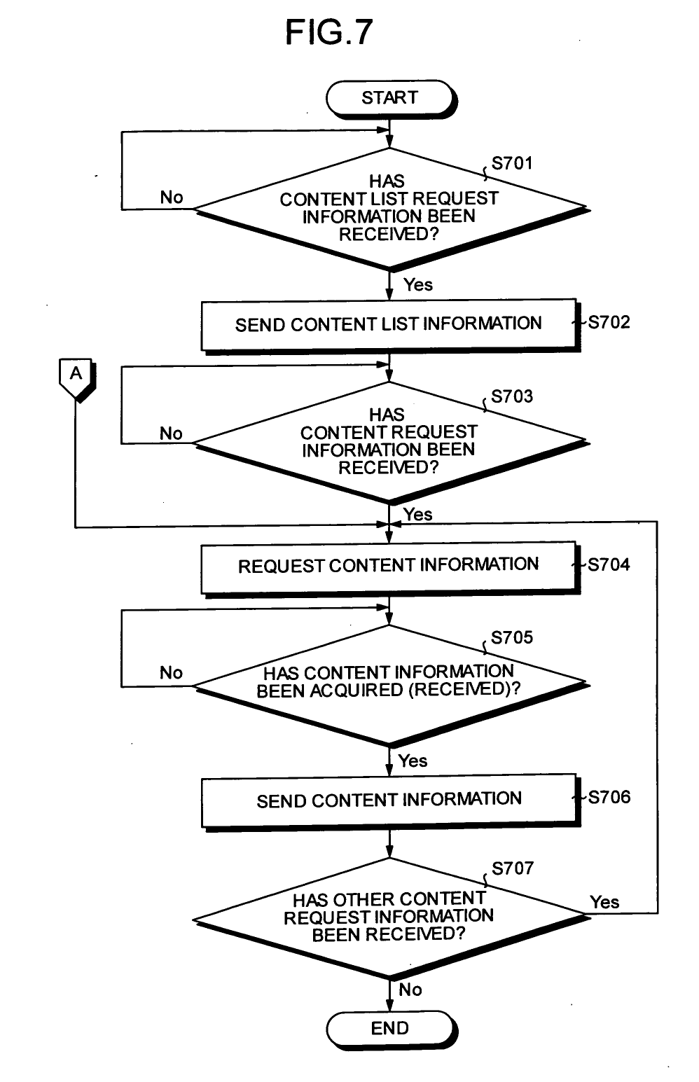

FIG. 7 is a flow chart of content providing process executed by the server system 201 according to the first embodiment. It is judged whether content list request information has been received from the PC 203 or the portable information processing terminal 205 of the user 103 (step S701). When content list request information is received (step S701: Yes), the content list information registered by the content list information registering unit 502 is sent to the PC 203 or the portable information processing terminal 205 of the user 103 that has sent the request (step S702).

Thereafter, it is judged whether the content request information has been received from the PC 203 or the portable information processing terminal 205 of the user 103 to whom the content list information has been sent (step S703). When the content request information is received (step S703: Yes), the content acquiring unit 506 requests content information to the server system 202 of the content provider 102 (step S704). Thereafter, when content information is acquired (received) (step S705: Yes), the acquired content information is sent to the PC 203 or the portable information processing terminal 205 of the user 103 that has sent the request (step S706).

Thereafter, it is judged whether other content request information has been received (step S707). If other content request information has been received (step S707: Yes), the procedures go to the step S704, and after this, the steps S704 to S707 are carried out repeatedly. If other content request information has not been received, for example, when a specified time has passed without receiving any other content request information (step S707: No), the series of processes are ended. Thus, contents are provided in response to the content request information from the user 103.

In the server system 201, when the content list request information is received, the ID of the user 103 is confirmed. However, when content request information is received, there is no need to confirm the ID of the user 103. This is because, in the latter instance, the confirmation of the user 103 can be made at the server system 202 of each content provider 102.

FIG. 8 is a flow chart of service condition (in concrete terms, the number of service times of each content) acquiring process executed by the server system 201 according to the first embodiment. As an example of the service condition memorizing unit 509, a number of service time counter (not shown) is reset (step S801). The number of service time counter is arranged per content.

Next, it is judged whether content request information has been received from the PC 203 or the portable information processing terminal 205 of the user 103 (step S802). Or, instead of receiving of the content request information, it can be judged whether content information has been sent in response to the content request information. When the content request information is received (step S802: Yes), it is judged whether the content requested in the content request information is a paid content, i.e., content provided by the content provider 102 (step S803). This is because the content request information from the user 103 is not always for paid contents, in other words, free content is requested in some cases.

If the content is not a paid content (step S803: No), the procedures go to a step S805 without doing anything. On the other hand, if the content is a paid content (step S803: Yes), the number of service time counter is incremented by only +1 (step S804), thereafter, the procedures go to a step S805.

Next, it is judged whether a specified time (such as one month, three months, six months, and one year) has passed (step S805). If the specified time has not passed (step S805: No), the procedures go to the step S802, thereafter the respective processes at the steps S802 to S805 are carried out repeatedly. On the other hand, if the specified time has passed (step S805: Yes), the number of service time information, i.e., information concerning the counter value of the number of service time counter is output to the dividend calculating unit 510 (step S806), and the series of the processes are ended. Thereby, it is possible to easily acquire the information concerning the number of service times per content.

FIG. 9 is a flow chart of service condition (in concrete terms, service time of each content) acquiring process executed by the server system 201 according to the first embodiment. As an example of the service condition memorizing unit 509, a service time information memorizing unit (not shown) is reset (step S901). The service time information memorizing unit is arranged per content.

Next, it is judged whether content request information has been received from the PC 203 or the portable information processing terminal 205 of the user 103 (step S902). Or, instead of receiving of the content request information, it can be judged whether content information has been sent in response to the content request information. When the content request information is received (step S902: Yes), it is judged whether the content requested in the content request information is a paid content, i.e., content provided by the content provider 102 (step S903).

If the content is not a paid content (step S903: No), the procedures go to a step S909 without doing anything. On the other hand, if the content is a paid content (step S903: Yes), counting of service time is started by a timer (not shown) (step S904).

Next, it is judged whether other content request information has been received from the PC 203 or the portable information processing terminal 205 of the user 103 (step S905). Or, instead of receiving of the content request information, it can be judged whether other content information has been sent in response to the content request information. If other content request information is received (step S905: Yes), the procedures go to a step S907. On the other hand, if other content request information is not received (step S905: No) and a specified time has passed from the start of counting of service time (step S906: Yes), it is judged that the user 103 does not use the paid contents any more, and the procedures go to the step S907.

Then, counting of service time is ended (step S907), and the contents of the service time information memorizing unit are updated (step S908). Namely, the service time of the content is added.

Next, it is judged whether a specified time (such as one month, three months, six months, and one year) has passed (step S909). If the specified time has not passed (step S909: No), the procedures go to the step S902, thereafter the respective processes at the steps S902 to S909 are carried out repeatedly. On the other hand, if the specified time has passed (step S909: Yes), the service time information, i.e., information memorized in the service time information memorizing unit is output to the dividend calculating unit 510 (step S910), and the series of the processes are ended. Thereby, it is possible to easily acquire the information concerning service time per content.

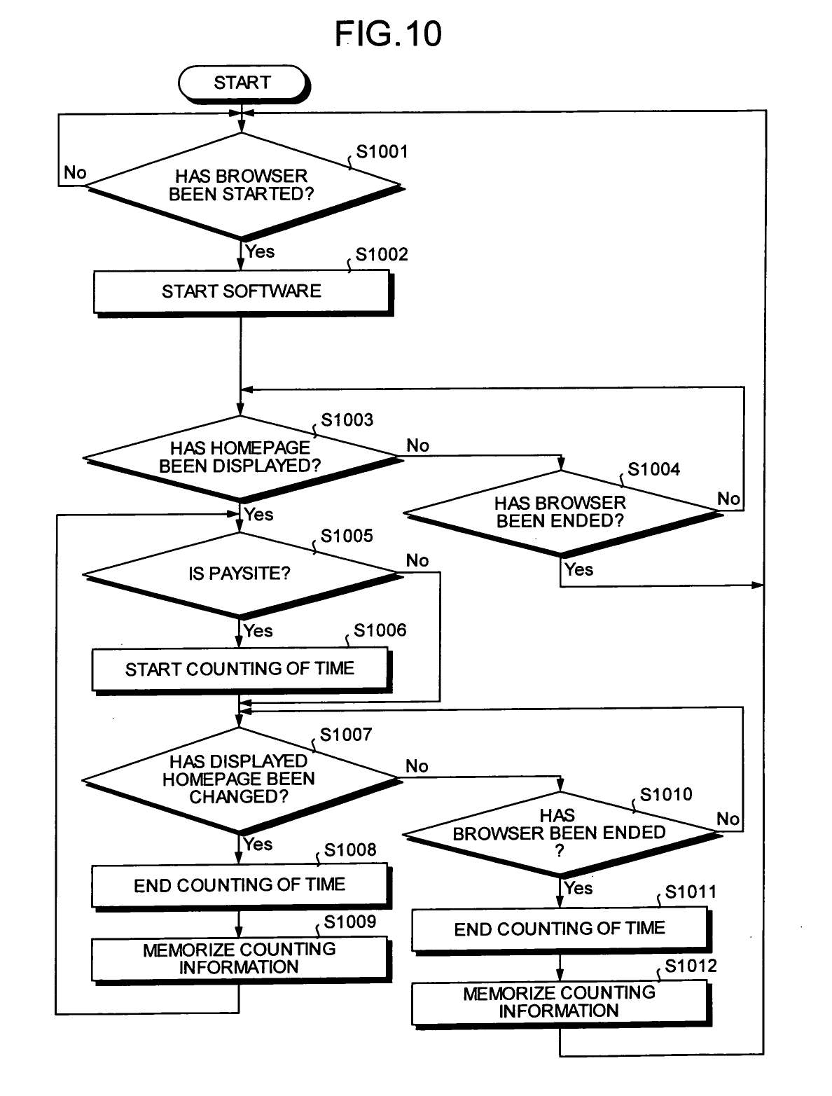

Service conditions, such as the information concerning the number of service times or service time, can be acquired by software installed into the PC 203 or the portable information processing terminal 205 of the user 103. FIG. 10 is a flow chart of process procedures executed by the software that is installed into the PC 203 or the portable information processing terminal 205 of the user 103.

It is judged whether a browser has been started in the PC 203 or the portable information processing terminal 205 of the user 103 (step S1001). When the browser has been started (step S1001: Yes), the installed software is started in connection with the start (step S1002).

Next, it is judged whether a homepage has been displayed on the browser (step S1003). If nothing is displayed (step S1003: No), then it is judged whether the browser has been ended (step S1004), and if the browser has been ended (step S1004: Yes), the software is ended and the procedures go back to the step S1001. On the other hand, if the browser has not been ended (step S1004: No), the procedures go back to the step S1003.

On the other hand, if a homepage has been displayed (step S1003: Yes), it is judged whether the displayed homepage is one of a paysite (step S1005). Then, if it is a paysite (step S1005: Yes), counting of time is started (step S1006). On the other hand, if it is not a paysite (step S1005: No), the procedures goes to a step S1007 without doing anything.

Next, it is judged whether the displayed homepage has been changed (step S1007). If the displayed homepage has been changed (step S1007: Yes), the counting of time that has been started at the step S1006 is ended (step S1008), and the counting information (information concerning counting time) is memorized (step S1009). Thereafter, the procedures go back to the step S1005, and the respective processes at the steps S1005 to S1009 are carried out repeatedly.

On the other hand, if the displayed homepage has not been changed (step S1007: No), then, it is judged whether the browser has been ended (step S1010). If the browser has not been ended (step S1010: No), the procedures go back to the step S1007. On the other hand, if the browser has been ended (step S1010: Yes), the counting of time that has been started at the step S1006 is ended (step S1011), and the counting information is memorized (step S1012). Thereafter, the procedures go back to the step S1001, and again, the start of the browser is waited for.

Thus, it is possible to easily acquire service conditions (the service time, in FIG. 10) by the software installed in the PC 203 or the portable information processing terminal 205 of the user 103. The memorized counting information is sent to the server system 201 at a specified time interval. Thereby, the server system 201 can acquire the information concerning the service time from the PC 203 or the portable information processing terminal 205 of the user 103.

FIG. 11 is an example of the portal homepage to be displayed on the PC 203 or the portable information processing terminal 205 of the user 103 according to the first embodiment of the present invention. As shown in FIG. 11, on a browser 1101 displayed on the display 308 or 404 of the PC 203 or the portable information processing terminal 205 of the user 103, thumbnails of paysites are displayed per category. The user 103 moves the cursor by the mouse 312 or the cursor control unit 407 such as a mouse onto the area where a desired site is displayed, and clicks the mouse button, thereby selects the site.

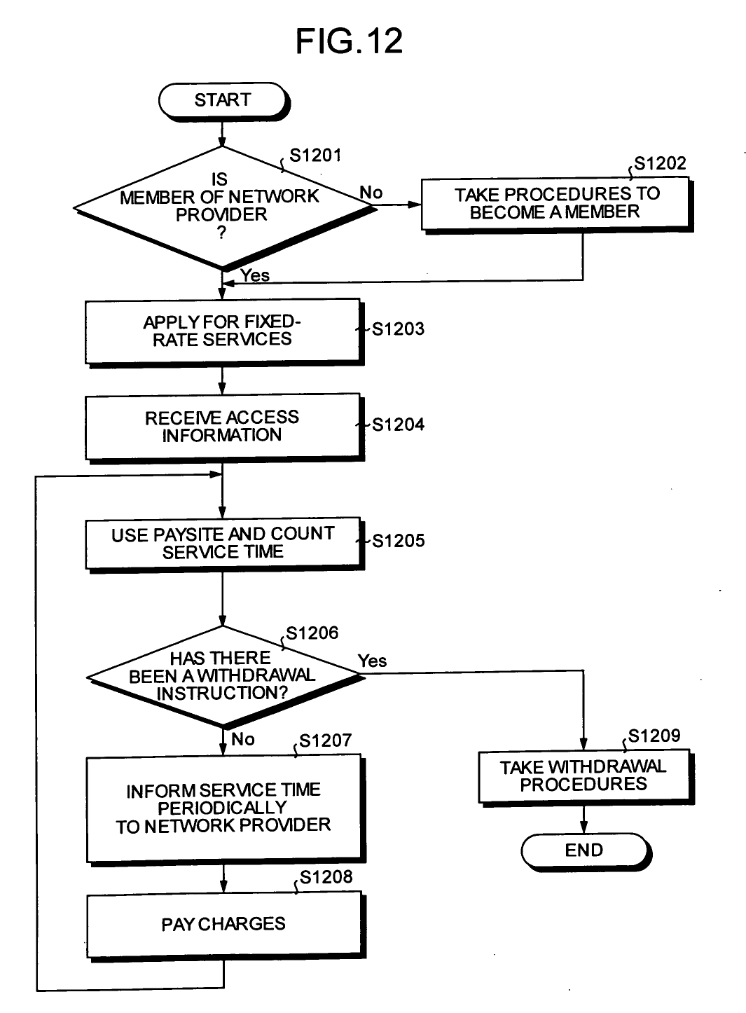

FIG. 12 is a flow chart of operating procedures of the user 103 according to the first embodiment of the present invention. If the user 103 has not become a member of the network provider 101 (step S1201: No), procedures to become a member is taken (step S1202). Thereafter, the user 103 applies for fixed-rate services for paysites to the network provider 101 (step S1203), and acquires access information for paysites (step S1204). As access information items to be acquired, there are an access ID, a URL of the portal homepage, a service time counting module (software) and so forth.

Thereafter, the paysite is used and browsing time (service time) is counted (step S1205). Then, it is judged whether there has been a withdrawal instruction (step S1206), and if there has not been a withdrawal instruction (step S1206: No.), the service time is informed periodically (for example, once in a week, or once in a month) to the network provider 101 (step S1207). The user 103 pays fixed-rate charges at a predetermined period (step S1208), and the procedures go back to the step S1205. Thereafter, the respective procedures of the steps S1205 to S1208 are carried out repeatedly. On the other hand, if there has been a withdrawal instruction (step S1206: Yes), withdrawal procedures are taken (step S1209), and the series of the procedures are ended.

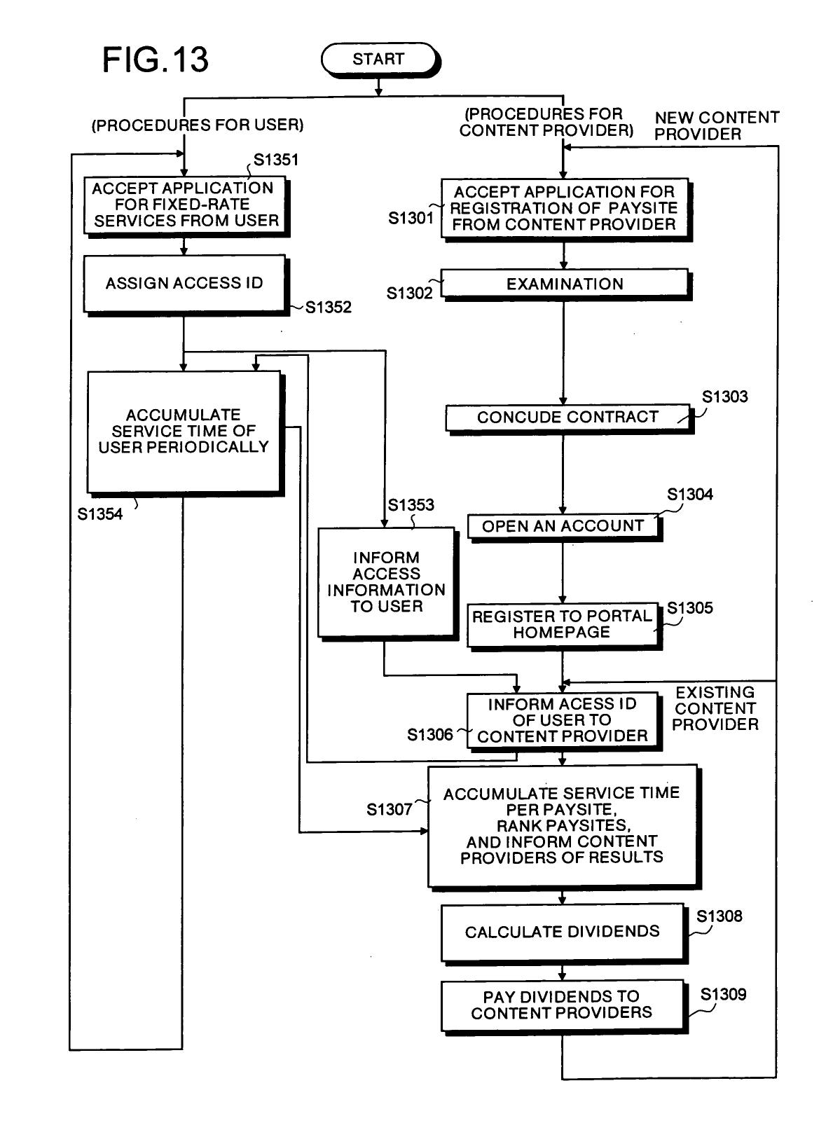

FIG. 13 is a flow chart of operating procedures of the network provider 101. As for procedures for the content provider 102, the network provider 101 accepts application for registration of paysite from the content provider 102 (step S1301). Thereafter, the network provider 101 conducts examination (step S1302), in concrete terms, such as contents of the paysite, financial conditions of the content provider 102, and viewpoints on public order and standards of decency are examined.

Next, the network provider 101 informs the content provider 102 of results of the examination, and if the content provider 102 acknowledges the results, a contract is concluded (step S1303). If the content provider 102 does not have an account, the content provider 102 opens an account (step S1304). Thereafter, the network provider 101 registers the site to the portal homepage (step S1305). Further, the network provider 101 informs the content provider 102 of the access ID of the users 103 (step S1306).

Thereafter, the network provider 101 accumulates the service time per paysite, ranks paysites, and informs respective content providers 102 of the results (step S1307). Thereby, it is possible to secure transparency of service conditions. Then, the network provider 101 calculates dividends (step S1308), and pays the calculated dividends to respective paysites (content providers 102) (step S1309). Thereafter, the steps S1306 to S1309 are carried out repeatedly. However, as for a new content provider 102, after the steps S1301 to S1305 are once carried out, the steps S1306 to S1309 are carried out repeatedly.

On the other hand, as for procedures for the user 103, the network provider 101 accepts an application for paysite services from the user 103 (step S1351). The network provider 101 assigns access information (access ID) to the user 103 (step S1352) and inform the user 103 of access information (step S1353). The service time of users 103 is acquired (accumulated) periodically (for example, once in a week, or once in a month) (step S1354), then the procedures go back to the step S1351.

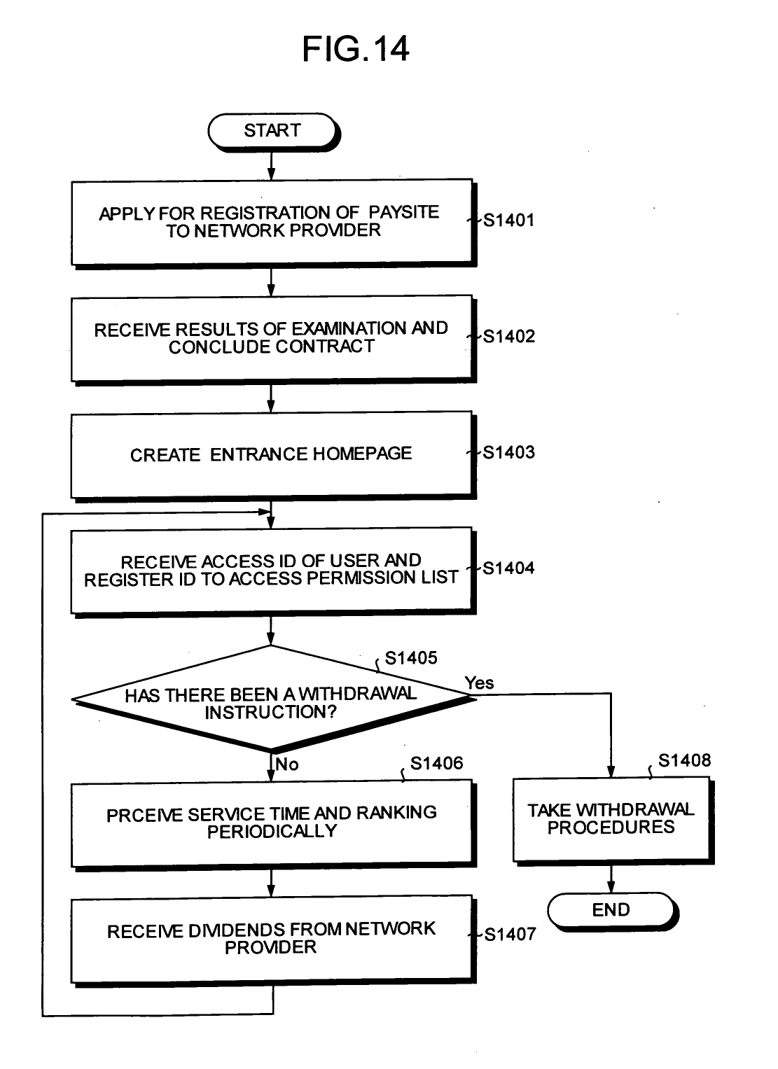

FIG. 14 is a flow chart of operating procedures of the content provider 102. The content provider 102 applies for registration of paysite to the network provider 101 (step S1401). Then, the content provider 102 receives the results of the examination on the application, and if the results are all right, a contract is concluded (step S1402). Then, the content provider 102 creates an entrance homepage whose thumbnail is displayed on the portal homepage shown in FIG. 11 (step S1403).

Thereafter, the content provider 102 receives access IDs of users 103, and the IDs are registered to the access permission list of paysites (step S1404).

Next, it is judged whether there has been a withdrawal instruction (step S1405), and if there has not been a withdrawal instruction (step S1405: No), the content provider 102 receives information concerning service time and ranking periodically (for example, once in a week, or once in a month) (step S1406). Further, the content provider 102 receives dividends from the network provider 101 at a predetermined period (step S1407), and the procedures go back to the step S1404. Thereafter, the respective procedures at the steps S1404 to S1407 are carried out repeatedly. On the other hand, if there has been a withdrawal instruction (step S1405: Yes), withdrawal procedures are taken (step S1408), and the series of the procedures are ended.

According to the first embodiment, it is possible to make paysite service charges from the users 103 into “fixed-rate” charges irrespective of the number of service times/service time, thereby it is possible to reduce burdens in sum of money of users. Further, because the network provider 101 collects paysite browsing charges, there is no need to input personal information such as a bank account number per content provider 102, accordingly, it is possible to guard the privacy of individuals.

Furthermore, in distribution to the content providers 102, it is possible to rank priority orders on which provider's contents are frequently browsed by use of browsing time or other methods, and based on the priority orders, to pay browsing charges or flexibly change distribution methods.

According to the first embodiment, for users, it is possible to use paysites at fixed-rate charges with a sense of security. It is possible for network providers 101 to position the paysite fixed-rate services as their services that differentiate them from other providers, and to attain the increased number of users. Further, for content providers 102, their profit distribution fluctuate according to their priority order rankings, therefore, those content providers who fulfill their contents further more than before and gain supports from users will attain further more achievements, while those content providers who do not will be dismissed.

In the first embodiment, contents (paysites) that content providers 102 provide are registered/stored at the side of content providers. On the other hand, in a second embodiment, these contents are registered in a server system 2201 of the network provider 101. Therefore, only differences from the first embodiment are explained, and identical codes are assigned to similar components to those in the first embodiment and explanations thereof are omitted herein.

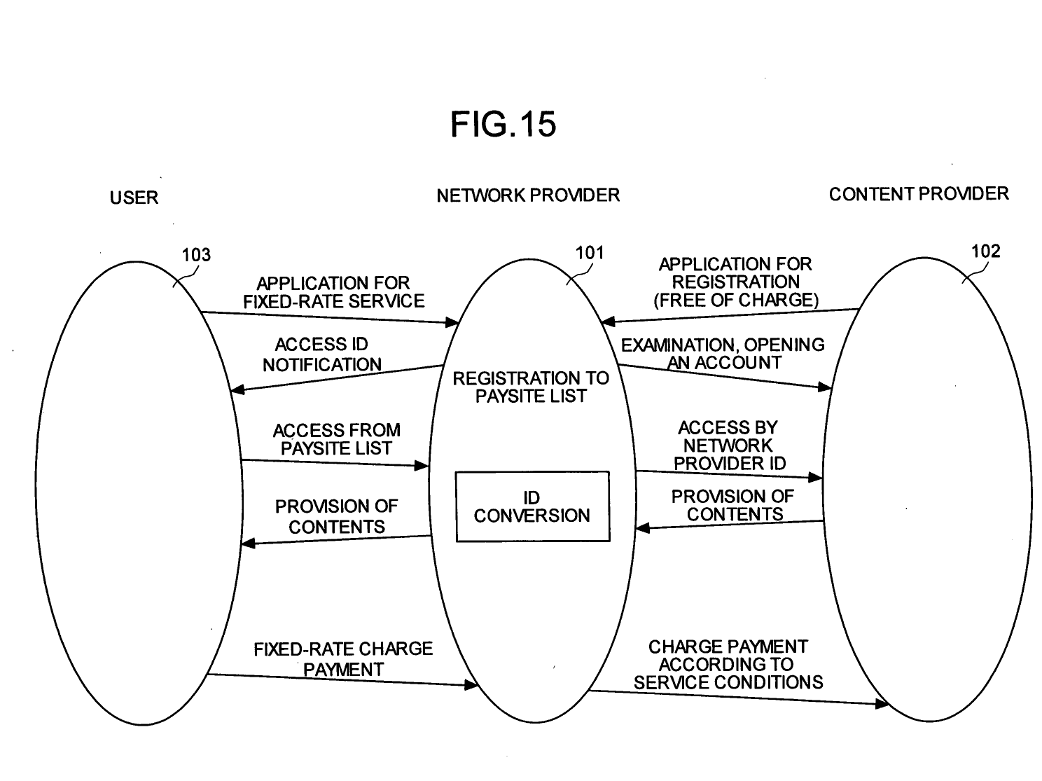

FIG. 15 is a schematic for outlining an information providing system according to the second embodiment of the present invention. In FIG. 15, in the same manner as in FIG. 1, the network provider 101 is what is called an ISP, the content provider 102 is a content provider who runs the paysite, and the user 103 is a user who uses (browses, listens to and views) the paid contents.

The difference from the first embodiment is that the network provider 101 accesses the content provider 102 with a network provider ID in advance, and receives the provision of contents, and registers the contents into the server system 2201 of the network provider 101. Then, at access from the user 103, the network provider 101 provides the registered contents to the user 103, without acquiring contents at necessity from the content provider 102.

Further, another difference from the first embodiment is that at access of the user 103, the network provider 101 converts an access ID of the user 103 into a network provider's unique ID. In concrete, in response to the application of the user 103, the network provider 101 adds the user 103 to an access ID control table (for example, a database). When the user 103 withdraws, the user 103 is deleted from the table, and the increase and decrease of the users 103 are handled by not the content provider 102 but the network provider 101. According to the second embodiment, the aforementioned service time counting software can be also utilized in service time calculations of paysites. However, it is possible for the network provider 101 itself to confirm access records individually by referring to the access ID control table at every access to paysites. In other words, in the second embodiment, service time can be calculated without introducing the aforementioned software.

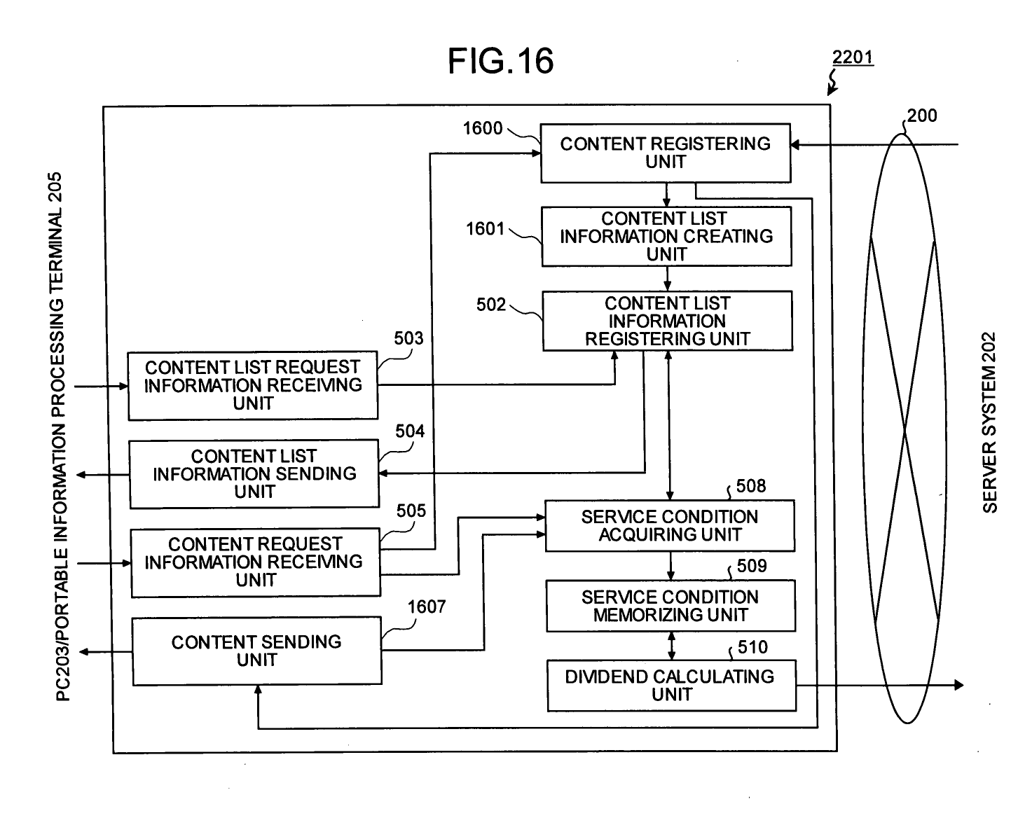

FIG. 16 is a block diagram of a functional configuration of the server system 2201 according to the second embodiment. In FIG. 16, the difference from FIG. 5 according to the first embodiment is that the server system 2201 further includes a content registering unit 1600. The content registering unit 1600 registers contents of information that can be provided via the Internet 200, such as text, image, audio, video and so forth, provided by the content provider 102. The content registering unit 1600 is realized by, for example the HD 305 and the HDD 304 that controls the HD 305 shown in FIG. 3.

A content list information creating unit 1601 creates content list information concerning a list of contents registered by the content registering unit 1600. A content sending unit 1607 sends the contents registered by the content registering unit 1600 to the PC 203 or the portable information processing terminal 205 of the user 103. Accordingly, there is no need to arrange the content acquiring unit 506 in the first embodiment. Other components are same as in the first embodiment, therefore, explanations thereof are omitted herein.

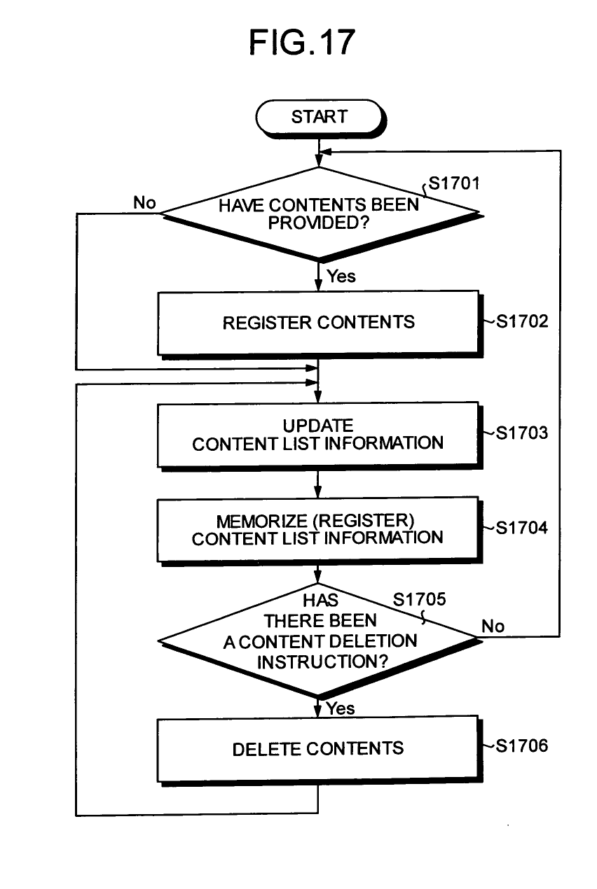

FIG. 17 is a flow chart of content registration process executed by the server system 2201 according to the second embodiment.

After the application for registration and the examination, it is judged whether contents have been provided (step S1701). The provision of contents includes the case where the server system 2201 of the network provider 101 accesses the server system 202 of the content provider 102 with a network provider's ID, and acquires contents. If contents have not been provided (step S1701: No), the procedures go to a step S1703 without doing anything. On the other hand, if contents have been provided (step S1701: Yes), the provided contents are registered (step S1702).

Next, content list information is updated by creating new content list information or changing existing content list information (step S1703). Then, the created or changed content list information is memorized (registered) (step S1704). Further, it is judged whether there has been a content deletion instruction (step S1705), and if there has been a content deletion instruction (step S1705: Yes), the contents concerned are deleted (step S1706), thereafter, the procedures go back to the step S1703. Then, the content list information is updated (step S1703).

On the other hand, if there has not been a content deletion instruction (step S1705: No), the procedures go back to the step S1701, and after that, the respective processes at the steps S1701 to S1706 are carried out repeatedly. Thereby, the creation/change of content list information is carried out at any time according to the addition/deletion of content registration, and the user 103 can acquire always latest content list information.

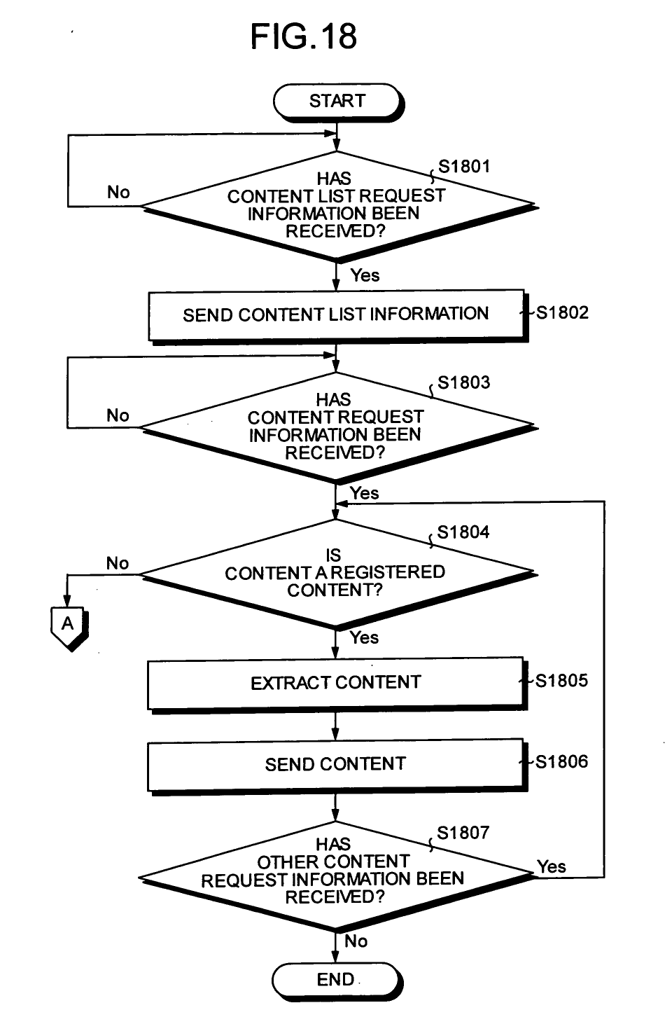

FIG. 18 is a flow chart of content providing process executed by the server system 2201 according to the second embodiment. The difference from FIG. 7 in the first embodiment is only steps S1804 and S1805.

In concrete, if content request information is received (step S1803: Yes), it is judged whether the requested content is the content registered in the content registering unit 1600 (step S1804). If it is a content not registered therein (step S1804: No), the procedures go to the step S704 shown in FIG. 7, and the same process as in the first embodiment is carried out.

On the other hand, if the requested content is registered in the content registering unit 1600 (step S1804: Yes), the content concerned is extracted from the content registering unit 1600 (step S1805), and the extracted content is sent to the PC 203 or the portable information processing terminal 205 of the user 103 that has sent the request (step S1806).

Thereafter, it is judged whether other content request information has been received (step S1807). If other content request information has been received (step S1807: Yes), the procedures go to the step S1804, and the steps S1804 to S1807 are carried out repeatedly. At the step S1807, if other content request information has not been received, for example, when a specified time has passed without receiving any other content request information (step S1807: No), the series of processes are ended. In this manner, contents are provided in response to the request for contents from the user 103.

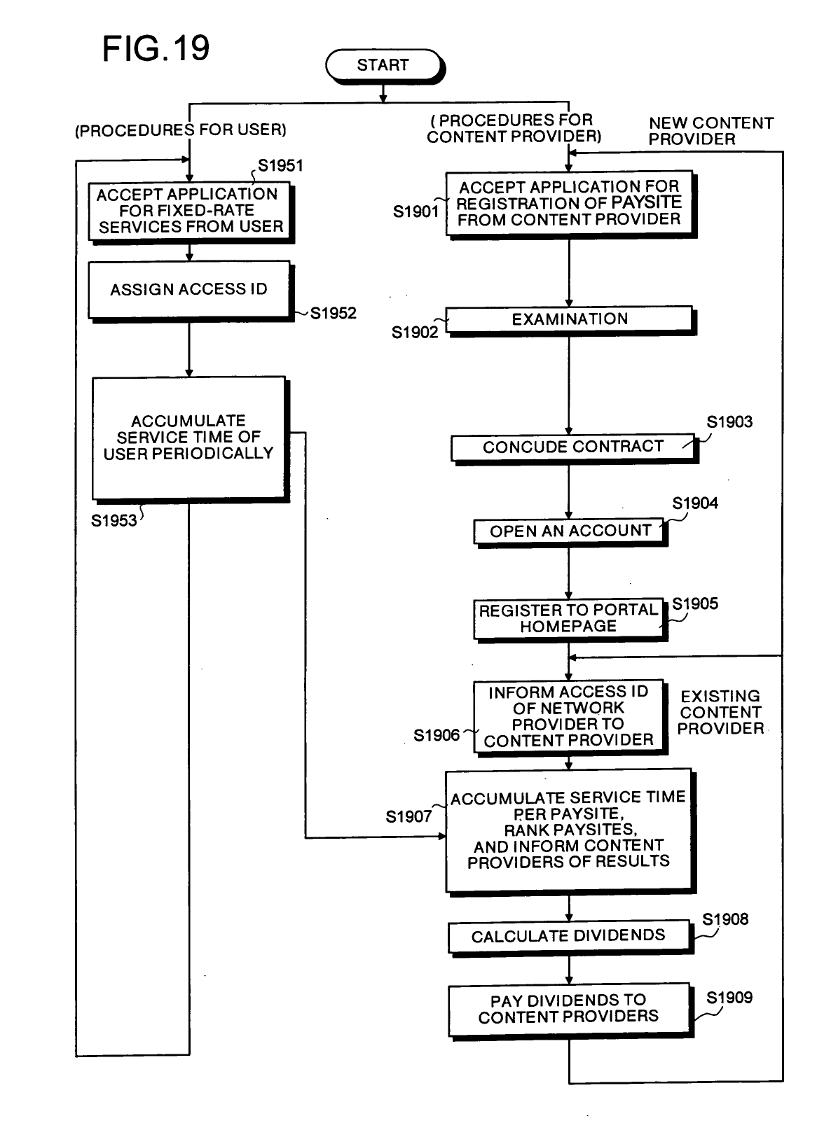

FIG. 19 is a flow chart of operating procedures of the network provider 101 according to the second embodiment. The difference from FIG. 13 in the first embodiment is only that in the place of informing of the access ID of the users 103 (step S706), the access ID of the network provider 101 is informed (step S1906).

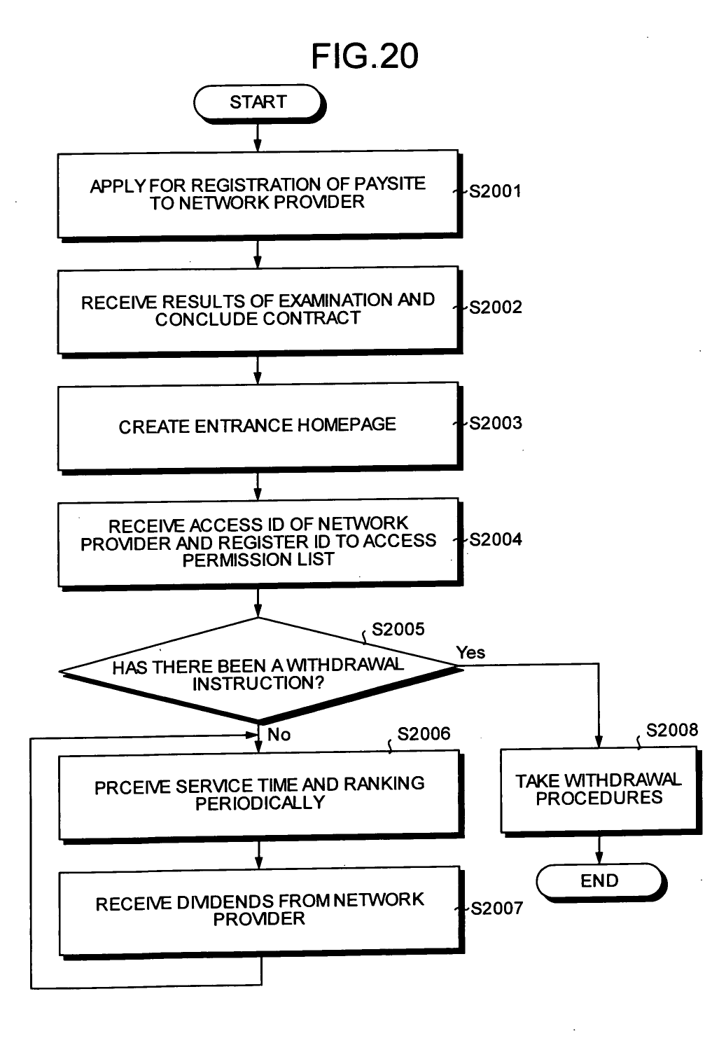

FIG. 20 is a flow chart of operating procedures of the content provider 102 according to the second embodiment. The difference from FIG. 14 in the first embodiment is only that, in the place of receiving access IDs of the users 103 and registering the IDs to the access permission list of paysites (step S1404), the content provider 102 sets only the access ID of the network provider 101 accessible to paysites (step S2004).

According to the second embodiment, it is possible to send contents to the user 103 promptly and precisely, irrespective of conjunction or disorder conditions of the Internet 200, also to easily and precisely acquire information about the number of service times, and service time of registered contents.

Further, for the user 103, personal information will not be leaked to the content provider 102, therefore, the privacy of the user 103 will be guarded, and the security of the user 103 will become safer.

Further, for the content provider 102, there is no need for ID control arising from the increase and decrease of users 103, therefore, its administrative affairs will be reduced. Further, the access ID is the ID that only the network provider 101 knows, i.e., the ID that will not be known to the outside, therefore, it is possible to prevent unauthorized accesses.

Furthermore, for the network provider 101, measures are taken for a system in consideration of security and privacy, and against unauthorized actions of the content provider 102, therefore, the reliability of the network provider 101 will be increased, and superiority to other network providers will be demonstrated.

The information providing methods according to the first embodiment and the second embodiment are realized by a program prepared in advance being executed on various computers such as a personal computer, a work station, and so forth, meanwhile, this program can be recorded into various computer readable recording media such as an HD, an FD, a CD-ROM, an MO, a DVD and the likes, and distributed via such recording media, and also can be distributed via a network such as the Internet.

As explained heretofore, according to the present invention, it is possible to efficiently provide paid contents on the Internet, and to efficiently and precisely collect service charges for these paid contents. Thereby, it becomes possible to increase services of paid content providers and the paid contents thereof, and also to facilitate the business of providing paid contents on the Internet.

As described heretofore, the information providing method, the computer-readable recording medium, and the server system according to the present invention are advantageous in distribution of paid contents provided on the Internet, and especially they are suitable for increasing services of paid content providers and the paid contents thereof, and also facilitating the business of providing paid contents on the Internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An information providing method to be executed by a server system of an internet network provider that connects to the Internet an information processing apparatus of a user authorized to access to contents provided by content providers in the Internet, comprising:
creating a content list that is a list of the contents;
receiving from the information processing apparatus a request for the content list;
sending the content list to the information processing apparatus in response to the request for the content list;
receiving from the information processing apparatus a request for a specific content included in the content list sent;
acquiring the specific content;
sending the specific content acquired to the information processing apparatus;
accumulating, for a predetermined duration information about use of the contents in the content list created; and
calculating dividends to the content providers, based on the information accumulated.

2. The information providing method according to claim 1, wherein the information is the information about the number of times in which the contents are used.

3. The information providing method according to claim 2, wherein at the accumulating, the information is accumulated based on any one of information about receiving conditions of the request for the specific content received at the receiving and information about sending conditions of the specific content sent at the sending.

4. The information providing method according to claim 1, wherein the information is the information about the time for which the contents are used.

5. The information providing method according to claim 4, wherein at the acquiring, the information is accumulated based on information about sending conditions of the specific content sent at the sending and information about receiving conditions of the request for the specific content received at the receiving.

6. An information providing method to be executed by a server system of an internet network provider that connects to the Internet an information processing apparatus of a user authorized to access to contents provided by content providers in the Internet, comprising:
registering the contents to the server system;
creating a content list that is a list of the contents registered;
receiving from the information processing apparatus a request for the content list;
sending the content list to the information processing apparatus in response to the request for the content list;
receiving from the information processing apparatus a request for a specific content included in the content list sent;
sending the specific content included in the contents registered to the information processing apparatus;
accumulating, for a predetermined duration, information about use of the contents registered; and
calculating dividends to the content providers, based on the information accumulated.

7. The information providing method according to claim 6, wherein the information is the information about the number of times in which the contents are used.

8. The information providing method according to claim 7, wherein at the accumulating, the information is accumulated based on any one of information about receiving conditions of the request for the specific content received at the receiving and information about sending conditions of the specific content sent at the sending.

9. The information providing method according to claim 6, wherein the information is the information about the time for which the contents are used.

10. The information providing method according to claim 9, wherein at the acquiring, the information is accumulated based on information about sending conditions of the specific content sent at the sending and information about receiving conditions of the request for the specific content received at the receiving.

11. A computer-readable recording medium that stores a computer program that is executed by a server system of an internet network provider that connects to the Internet an information processing apparatus of a user authorized to access to contents provided by content providers in the Internet, the computer program causing the server system execute:
creating a content list that is a list of the contents;
receiving from the information processing apparatus a request for the content list;
sending the content list to the information processing apparatus in response to the request for the content list;
receiving from the information processing apparatus a request for a specific content included in the content list sent;
acquiring the specific content;
sending the specific content acquired to the information processing apparatus;
accumulating, for a predetermined duration, information about use of the contents in the content list created; and
calculating dividends to the content providers, based on the information accumulated.

12. A computer-readable recording medium that stores a computer program that is executed by a server system of an internet network provider that connects to the Internet an information processing apparatus of a user authorized to access to contents provided by content providers in the Internet, the computer program causing the server system execute:
registering the contents to the server system;
creating a content list that is a list of the contents registered;
receiving from the information processing apparatus a request for the content list;
sending the content list to the information processing apparatus in response to the request for the content list;
receiving from the information processing apparatus a request for a specific content included in the content list sent;
sending the specific content included in the contents registered to the information processing apparatus;
accumulating, for a predetermined duration, information about use of the contents registered; and
calculating dividends to the content providers, based on the information accumulated.

13. A server system of an internet network provider that connects to the Internet an information processing apparatus of a user authorized to access to contents provided by content providers in the Internet, comprising:
a creating unit that creates a content list that is a list of the contents;
a receiving unit that receives from the information processing apparatus a request for the content list;
a sending unit that sends the content list to the information processing apparatus in response to the request for the content list;
a receiving unit that receives from the information processing apparatus a request for a specific content included in the content list sent;
a acquiring unit that acquires the specific content;
a sending unit that sends the specific content acquired to the information processing apparatus;
a accumulating unit that accumulates, for a predetermined duration, information about use of the contents in the content list created;
a memorizing unit that memorizes the information accumulated; and
a calculating unit that calculates dividends to the content providers, based on the information memorized.

14. A server system of an internet network provider that connects to the Internet an information processing apparatus of a user authorized to access to contents provided by content providers in the Internet, comprising:
a registering unit that registers the contents;
a creating unit that creates a content list that is a list of the contents registered;
a receiving unit that receives from the information processing apparatus a request for the content list;
a sending unit that sends the content list to the information processing apparatus in response to the request for the content list;
a receiving unit that receives from the information processing apparatus a request for a specific content included in the content list sent;
a sending unit that sends the specific content included in the contents registered to the information processing apparatus;
a accumulating unit that accumulates, for a predetermined duration, information about use of the contents registered;
a memorizing unit that memorizes the information accumulated; and
a calculating unit that calculates dividends to the content providers, based on the information memorized.
